(19) United States
(12) Patent Application Publication
(10) Pub. No.: US 2014/0275334 A1
(43) Pub. Date: Sep. 18, 2014

(54) Hollow Glass Micro Particles Used As Anti-Blocking System In Hot Melts

(71) Applicant: H.B. Fuller Company, St. Paul, MN (US)

(72) Inventor: Joaquim Serra, Porto (PT)

(21) Appl. No.: 14/352,038

(22) PCT Filed: Oct. 17, 2012
(86) PCT No.: PCT/US2012/060551

§ 371 Date: Apr. 15, 2014

(30) Foreign Application Priority Data
Oct. 17, 2011 (EP) 11185482.4

(51) Int. Cl. C09J 123/02; C08K 7/28; B29B 9/06

(52) U.S. Cl. CPC C09J 123/02; B29B 9/06; C08K 7/28
USPC 523/219; 427/180; 264/131

(57) ABSTRACT

The present invention concerns a hot melt composition having improved anti-blocking properties. In particular, the present invention is directed to a hot melt composition in the form of particulate units, the particulate units having a surface which is at least partially covered by hollow glass micro particles.

### CROSS REFERENCE TO RELATED APPLICATION

This application claims the benefit of European Patent Application No. 11 185 482.4, filed Oct. 17, 2011 and incorporated herein.

### FIELD OF THE INVENTION

The present invention relates to hot melt compositions, and more specifically to anti-blocking agents for hot melt compositions. The present invention further relates to hot melt particulate units which are free flowing and have a substantially tack-free surface, and their manufacture.

### BACKGROUND OF THE INVENTION

Hot melt compositions or hot melts are thermoplastic materials which are solid at ambient temperature and are generally applied to a substrate while in the molten state. After the hot melts have been solidified again, they may exert different functions. For example, they can provide a solvent-free adhesive for bonding.

Depending on their composition, the packaging, transportation, storage, or further processing of hot melts may lead to problems in industry due to agglomeration of the hot melt being in the form of pellets, blocks or other particulate units. This agglomeration, for example, may disable a correct use of hot melts in customer processes, either because it is very difficult to remove the hot melts from the storage bag, or because it creates major issues in semi-automatic processes where pumping of hot melt granules such as prills or pellets is used to feed the melting tanks. Also in machines where pre-melters are used, agglomeration can be problematic since it may lead to situations of discontinuous feed of hot melt. These problems can occur, for example, with amorphous poly-α-olefin-(APAO)-based hot melts, which typically possess some residual or permanent tack at room temperature.

Currently, anti-blocking powders such as talc, wax, or silica are used in the discharge of hot melts to avoid agglomeration. However, these compounds tend to become completely absorbed over time by the hot melt, and, as a result, the residual tack reappears. Furthermore, some of the currently used anti-blocking agents such as silica dust are potentially harmful or can cause serious health damage, for example, lung or respiratory problems.

U.S. Pat. No. 5,869,555 discloses a hot melt composition having a tack-free surface prior to melting. An anti-blocking coating based on cellulose acetate butyrate for pressure sensitive hot melt adhesives is described in U.S. Pat. No. 6,083,630. U.S. Pat. No. 4,645,537 discloses an aqueous release agent comprising aliphatic alcohols and aliphatic hydroxy dicarboxylic or tricarboxylic acids. A low tack adhesive layer comprising displaceable or fracturable microparticles is described in U.S. Pat. No. 6,020,062.

There remains a need in the art for an anti-blocking agent which improves the handling of hot melts and prevents agglomeration permanently and reliably.

### SUMMARY OF THE INVENTION

It is an object of the present invention to provide an anti-blocking agent or additive which ensures that particulate units, such as granules as defined below, of a hot melt composition are not agglomerated during their packaging, transportation, storage, or further processing. Another object of the present invention is to provide an anti-blocking agent that is not absorbed over time by the hot melt, or which is not potentially harmful to health. It would also be desirable to provide an anti-blocking agent which is highly effective in preventing the agglomeration of hot melt granules over time. Furthermore, it would be desirable to provide an anti-blocking agent which allows easy de-agglomeration of some blocked hot melt particulate units, for example, when high pressure is applied to the hot melt during transportation or storage, or when the hot melt is transported or stored at elevated ambient temperatures, for example, at a temperature of more than 25° C. It would also be advantageous to provide an anti-blocking agent which does not undesirably change the characteristics of the hot melt composition after melting.

Furthermore, it is an object of the present invention to provide a hot melt composition comprising such an anti-blocking agent or additive. It would be desirable to provide a hot melt composition having a reduced tackiness while the other properties and the purity of the hot melt composition remains unaffected. It is also an object of the present invention to provide hot melt particulate units which are free flowing and/or have a substantially tack-free surface for extended periods of time.

The foregoing and other objects are solved by a hot melt composition in the form of particulate units, the particulate units having a surface which is at least partially coated by hollow glass micro particles.

According to another aspect of the present invention, the use of hollow glass micro particles as anti-blocking additives for hot melt compositions is provided.

According to still another aspect of the present invention, a method for preparing hot melt particulate units is provided, comprising the steps of
(a) providing particulate units of a hot melt composition, and
(b) contacting said particulate units with hollow glass micro particles, to at least partially cover the surface of the particulate units with hollow glass micro particles adhering to the surface.

According to still another aspect of the present invention, a method to prevent or reduce blocking of a hot melt composition is provided comprising contacting a hot melt composition in the form of particulate units with hollow glass micro particles.

According to still another aspect of the present invention, a use of the inventive hot melt composition as a hot melt pressure sensitive adhesive or hot melt adhesive is provided.

Advantageous embodiments of the present invention are defined in the corresponding sub-claims.

According to one embodiment the micro particles have an average particle size d₅₀ from 1 to 200 μm, preferably from 5 to 150 μm, more preferably from 10 to 100 μm, and most preferably from 20 to 80 μm. According to another embodiment the micro particles have a density of less than 0.50 g/cm³, preferably less than 0.30 g/cm³, more preferably less than 0.20 g/cm³, and most preferably less than 0.15 g/cm³. According to still another embodiment the micro particles are present in an amount from 0.1 to 10 wt.-% based on total weight of the hot melt composition, preferably from 0.2 to 5.0 wt.-%, more preferably from 0.3 to 1.0 wt.-%, and most preferably from 0.5 to 0.7 wt.-%. According to still another embodiment the hollow glass microparticles are selected from silicon dioxide, quartz, soda-lime glass, borosilicate glass, sodium borosilicate glass, or soda-lime borosilicate glass, or any mixture thereof.

According to one embodiment the hot melt composition comprises at least 10 wt.-% of at least one amorphous poly-α-olefin (APAO), based on the total weight of the hot melt composition, preferably from 10 to 90 wt.-%, more preferably from 25 to 75 wt.-%, and most preferably from 30 to 50 wt.-%. According to another embodiment the at least one amorphous poly-α-olefin is selected from homopolymers of propylene or copolymers of propylene with one or more α-olefin comonomer, preferably ethylene, 1-butene, 1-hexene, and 1-octene, preferably the at least one amorphous poly-α-olefin is selected from the group consisting of propylene homopolymer, propylene-ethylene copolymer, propylene-1-butene copolymer, and propylene-ethylene-1-butene terpolymer.

According to one embodiment the hot melt composition further comprises a tackifying resin, preferably in an amount from 5 to 75 wt.-% based on total weight of the hot melt composition, more preferably from 10 to 60 wt.-%, and most preferably from 15 to 50 wt.-%. According to another embodiment the hot melt composition comprises a plasticizer, preferably in an amount from 1 to 20 wt-% based on the total weight of the hot melt composition, more preferably from 1 to 10 wt.-%, and most preferably from 1 to 7 wt.-%.

According to one embodiment the hot melt composition is a hot melt pressure sensitive adhesive or a hot melt adhesive.

According to one embodiment the particulate units include at least one of granules, blocks, pillows, elongated ropes or rods. According to another embodiment the particulate units are granules having a size from 0.1 to 20 mm, preferably from 1 to 10 mm, more preferably from 2 to 8 mm, and most preferably from 3 to 6 mm.

According to one embodiment the hot melt composition has a tack-free surface and/or is free flowing at ambient conditions.

According to one embodiment the particulate units are granules, wherein the granules of step (a) of the inventive method are prepared by a method comprising the steps of
(i) providing one or more hot melt components and blending the hot melt components to form a homogeneous hot melt composition,
(ii) forcing the homogeneous hot melt composition through a die having a series of voids in a circular pattern to form a series of homogeneous hot melt ribbons,
(iii) further forcing said homogeneous hot melt ribbons past rotating blades in parallel position to said die, and cutting the hot melt ribbons to form resultant granules,
(iv) solidifying the granules by use of a liquid cooling medium being circulated past said die and rotating blades on the side where the hot melt ribbons emerge, and
(v) transporting the hot melt granules to a drying area and removing liquid by blowing the obtained granules.

### DETAILED DESCRIPTION OF THE INVENTION

According to the present invention a hot melt composition in the form of particulate units is provided which is at least partially covered by a layer of hollow glass micro particles. According to a further aspect of the present invention, hot melt particulate units are provided comprising a hot melt composition, wherein the surface of the hot melt particulate units is at least partially covered with hollow glass micro particles. In the following, the hollow glass micro particles that are used as anti-blocking additive and the hot melt composition will be described in more detail as well as hot melt particulate units comprising said anti-blocking additive.

### The Hollow Glass Micro Particles

According to the present invention hollow glass micro particles are used as an anti-blocking additive for a hot melt composition. According to another aspect of the present invention, a method to prevent or reduce blocking of a hot melt composition is provided, comprising contacting the hot melt with hollow glass micro particles to at least partially cover the surface of the hot melt composition with the hollow glass micro particles.

The term “micro particle” as used in the context of the present invention refers to a physical form or shape of the anti-blocking additive having a size, in the longest dimension, in the micrometer range, e.g., a particle size from 1 to 200 μm, and includes, for example, a pellet, granule, chip, powder, flake, sphere, or any other form or shape suitable for use as an anti-blocking additive. In preferred embodiments, the hollow glass micro particles are substantially spherical having an average diameter in the above mentioned size ranges.

The inventor surprisingly found that hollow glass micro particles effectively prevent the agglomeration of hot melt compositions, e.g. hot melt granules or other hot melt particulate units, over extended periods of time. Furthermore, the addition of hollow glass micro particles allows an easy de-agglomeration of potentially blocked hot melt particulate units. It was also found that hollow glass micro particles are particularly useful as anti-blocking agents in APAO-based hot melts which typically possess some residual or permanent tack, particularly at elevated ambient temperatures. In particular, the inventors found that the anti-blocking properties of hollow glass micro particles are not adversely affected when the hot melt is exposed to higher ambient temperatures (e.g. between 25 and 40° C.), for example, during storage or transportation. This makes the inventive anti-blocking agent very reliable.

Without being bound to a specific theory, it is believed that the effectiveness of the hollow glass micro particles as an anti-blocking agent is a result of the chemical and physical characteristics of the particles, supported by the fact that hollow glass micro particles are not completely absorbed over time during storage by the hot melt composition, as with many other anti-blocking additives. In this regard, it is noted that conventional anti-tack coated hot melt compositions during the storage at high room temperatures (25-40° C.) tend to “absorb” the anti-tack powder, thus deteriorating the anti-tack effectiveness. It was observed, that this does not happen with the rather large sized (compared to, e.g. talc powder and other standard anti-agglomeration powders) hollow glass micro particles of comparably low density.

Furthermore, some of the conventional anti-blocking agents such as silica create inhalable dusts that are potentially harmful or can cause serious health damage, for example, lung or respiratory problems. Hollow glass micro particles are less inhalable and dusts of the micro particles, which may be formed during their handling, tend to disappear much faster due to the quicker deposition of the particles. This reduces health risks and expenses for filters and air cleaning equipment. Consequently, hollow glass micro spheres provide a favorable, environmentally friendly and safe alternative to silica as an anti-blocking agent for hot melt adhesive granules or other particulate units of hot melt adhesives.

The hollow glass micro particles may be in the form of spheres or bubbles, may have a more elliptic or rod-like shape, or may be irregularly shaped. According to a preferred embodiment, the hollow glass micro particles are in the form of spheres.

According to one embodiment of the present invention the hollow glass micro particles have an average particle size d₅₀ from 1 to 200 μm. Preferably, the hollow glass micro particles have an average particle size d₅₀ from 5 to 150 μm, more preferably from 10 to 100 μm, and most preferably from 20 to 80 μm.

Throughout the present document, the term “particle size” is described by its distribution of particle sizes. The value dₓ represents the diameter relative to which x % by weight of the particles have diameters less than dₓ. The d₅₀ value is thus the weight median particle size, i.e. 50 wt.-% of all particles are bigger or smaller than this particle size. For the purpose of the present invention the particle size is specified as weight median particle size d₅₀ unless indicated otherwise. To determine the weight median particle size d₅₀ value for particles having a d₅₀ value between 0.4 and 2 μm, routine equipment such as a Sedigraph 5120 device of Micromeritics, USA, may be used.

The hollow glass micro particles may have a density of less than 0.50 g/cm³, preferably less than 0.30 g/cm³, more preferably less than 0.20 g/cm³, and most preferably less than 0.15 g/cm³. The inventors surprisingly found that hollow glass micro spheres having a density of less than 0.50 g/cm³ are especially suitable as an anti-blocking additive, and typically adhere particularly well to the surface of hot melt compositions.

According to one embodiment of the present invention, the hollow glass micro particles have an average particle size d₅₀ from 1 to 200 μm and a density of less than 0.50 g/cm³. According to another embodiment of the present invention, the hollow glass micro particles are hollow glass spheres having an average particle size d₅₀ from 1 to 200 μm and a density of less than 0.50 g/cm³.

The glass micro particles can be made of any glass material. According to one embodiment of the present invention, the hollow glass micro particles are selected from silicon dioxide, quartz, soda-lime glass, borosilicate glass, sodium borosilicate glass, or soda-lime borosilicate glass, or any mixtures thereof.

The hollow glass micro particles may be present in an amount from 0.1 to 10 wt.-%, based on the total weight of the hot melt composition. Preferably, the hollow glass micro particles are present in an amount from 0.2 to 5.0 wt.-%, based on total weight of the hot melt composition, more preferably from 0.3 to 1.0 wt.-%, and most preferably from 0.5 to 0.7 wt.-%.

According to the present invention, the surface of the hot melt composition is at least partially covered with hollow glass micro particles, e.g., by a layer of the particles on the surface of the hot melt composition or particulate units, respectively. For the purpose of the present invention, the term “at least partially covered” means that at least 10%, preferably more than 25%, more preferably more than 50%, and most preferably more than 75% or more than 90% of the surface of the particulate units of the hot melt composition are covered by a layer of hollow glass micro particles. According to one embodiment, the surface of the hot melt composition particulate units is substantially completely covered by at least one surface layer of hollow glass micro particles. The present invention does not aim to the provision of hot melt compositions in the form of particulate units, wherein the hollow glass micro particles are dispersed within the hot-melt composition.

### The Hot Melt Composition

For the purpose of the present invention, the term “hot melt” or “hot melt composition” refers to a solvent free product which is more or less solid at room temperature, i.e. at a temperature between 20 and 25° C. When heated the hot melt becomes tacky and can be applied, for example, to a substrate to provide an adhesive surface.

The present invention is not specifically limited with respect to the polymer being used. Rather, any polymer that in principle can be used in hot melt compositions is suitable according to the present invention. This refers to thermoplastic polymers selected, e.g., from ethylene and propylene homo- and co-polymers and mixtures thereof. Other suitable polymers for hot melt compositions are polyamides and polyesters, polyurethanes, or styrene block copolymers. Also useful are amorphous poly-α-olefins (APAO) such as atactic propylene, and propylene copolymers with ethylene, butene, hexene, and octene.

According to one embodiment of the present invention, the hot melt composition is an amorphous poly-α-olefin (APAO) based hot melt composition. The hot melt composition may comprise at least 10 wt.-% of at least one amorphous poly-α-olefin (APAO), based on the total weight of the hot melt composition. According to one embodiment of the present invention, the hot melt composition comprises at least 25 wt.-%, preferably at least 50 wt.-%, more preferably at least 75 wt.-%, and most preferably at least 90 wt.-% of a APAO.

Preferably the hot melt composition comprises from 10 to 90 wt.-%, more preferably from 25 to 75 wt.-%, and most preferably from 30 to 50 wt.-% of a APAO, based on the total weight of the hot melt composition.

Poly-α-olefins (APAO) may consist of several different categories of atactic, low molecular weight, low melt viscosity, and substantially amorphous propylene based polymers. These polymers can be either homopolymers of propylene or copolymers of propylene with one or more α-olefin comonomer, such as, for example, ethylene, 1-butene, 1-hexene, or 1-octene. The average weight molecular weight of the APAO polymers in the scope of the present invention may be in the range of from 4000 to 150000 g/mol, preferably from 10000 to 100000 g/mol. The said polymers may have a softening point between about 80 and 170° C. and a glass transition temperature from about −5 to −40° C. APAO polymers are usually predominantly amorphous without a well-defined melting point. However, APAO polymers may exhibit some degree of crystallinity. For example, there are some grades of commercial APAO products having a low degree of crystallinity.

The APAO polymers may be functionalized, e.g., by contacting the polymer with at least one functional group, an unsaturated monomer. Examples for suitable unsaturated monomers are carboxylic acids, dicarboxylic acids, organic esters, organic anhydrides, organic alcohols, organic acid halides, organic peroxides, amides, or imides.

According to one embodiment the at least one amorphous poly-α-olefin is selected from homopolymers of propylene or copolymers of propylene with one or more α-olefin comonomer. Preferably the α-olefin comonomer is selected from the group consisting of ethylene, 1-butene, 1-hexene, and 1-octene. Preferably the at least one amorphous poly-α-olefin is selected from the group consisting of propylene homopolymer, propylene-ethylene copolymer, propylene-1-butene copolymer, and propylene-ethylene-1-butene terpolymer.

However, any other APAO polymer falling in the range of physical properties described above can also be used.

APAO polymers that may be used in the hot melt of the present invention are, for example, available from REXtac LLC, Odessa, Tex., USA, under the trade name of Rextac™ such as RT-2280 and RT-2315 and RT-2585.

Other polymers that may be useful in the hot melt composition of the present invention include metallocene catalyzed polymers including homopolymers and interpolymers of ethylene, propylene, or butene including, e.g., substantially linear interpolymers of ethylene with at least one C₂ to C₂₀-α-olefin, further characterized by each said interpolymer having a polydispersity less than about 2.5 including such polymers as Exact™5008, an ethylene-butene copolymer, Exxpol SLP-0394™, and ethylene-propylene copolymer, Exact™3031, an ethylene-hexene copolymer, all available from Dow Chemical Co. in Midland, USA.

Other polymers that may be useful in the hot melt composition of the present invention are homopolymers, copolymers and terpolymers of ethylene. Preferred are copolymers of ethylene with one or more polar monomers, such as vinyl acetate or other vinyl esters of monocarboxylic acids, or acrylic or methacrylic acid or their esters with methanol, ethanol or other alcohols.

According to one embodiment of the present invention, the hot melt composition comprises a polymer selected from the group consisting of ethylene vinyl acetate, ethylene methyl acrylate, ethylene n-butyl acrylate, ethylene acrylic acid, ethylene methacrylate, ethylene 2-ethylhexylacrylate, ethylene octane, ethylene butene and mixtures and blends thereof. Said polymers may be present in an amount from 0 to 20 wt.-%, preferably from 1 to 15 wt.-%, from 2 to 12 wt.-%, or from 5 to 10 wt.-%, based on the total weight of the hot melt composition.

The hot melt composition of the present invention may be a hot melt pressure sensitive adhesive or a hot melt adhesive.

The hot melt composition may be in any form suitable for its use, including any particulate units, irrespective of size. For the purpose of the present invention the term “particulate units” refers to three-dimensional autonomic objects or pieces that can be used independently in further applications, e.g. in the production of adhesives. According to the present invention, “particulate units” may comprise hot melt compositions in the form of granules, blocks, pillows, elongated ropes or rods, or any other known form of hot melts, which may also be at least partially coated with hollow glass micro particles in accordance with the invention. The elongated ropes or rods can be of any length, and, e.g., can be wound onto a reel or spoon and applied from there. Particulate units such as blocks, pillows, elongated ropes or rods may have a size, in the longest dimension, in the range of centimeters, for example up to 15 cm or up to 20 cm. For example, the elongated ropes or rods may have a length between 1 and 10 cm, preferably between 2 and 8 cm or 3 and 7 cm, and a diameter between 0.5 and 3 cm, preferably between 1 and 2 cm. In certain embodiments, the hot melt composition are in the form of granules, the term “granules” including any smaller sized particulate units, such as particles, prills, chips, flakes, spheres, beads, slugs, e.g. sausage shaped slugs, or pellets. “Particulate units” in the meaning of the present invention are not layers, films, sheets, or coatings of hot melt compositions, which are, for example, formed on a substrate. Rather, the “particulate units” of the present invention are bulk materials that are pourable. They can be directly employed in the desired application, for example, in the production of hot melt adhesives.

According to one embodiment of the present invention, the particulate units are selected from at least one of blocks, pillows, elongated ropes or rods. According to another embodiment of the present invention, the particulate units are granules, the granules being preferably selected from at least one of particles, prills, chips, flakes, spheres, beads, slugs, or pellets. Such granules may have an average size from 0.1 to 20 mm, more preferably from 1 to 10 mm, still more preferably from 2 to 8 mm, and most preferably from 3 to 6 mm.

According to one preferred embodiment of the present invention, the hot melt composition granules are in form of prills. A “prill” in the meaning of the present invention refers to a spherical bead. Preferably, the prills have an average size from 0.1 to 20 mm, more preferably from 1 to 10 mm, still more preferably from 2 to 8 mm, and most preferably from 3 to 6 mm.

According to one embodiment of the present invention, the average size of the granules, preferably prills, is greater than the average particle size d₅₀ of the hollow glass micro particles. According to one preferred embodiment, the average size of the granules, preferably prills, is 5 times greater, preferably 10 times greater, more preferably 20 times greater, and most preferably 50 times greater than the average particle size d₅₀ of the hollow glass micro particles.

According to one embodiment of the present invention the hot melt composition which is at least partially covered with hollow glass particles has a tack-free surface and/or is free-flowing, preferably for extended periods of time, such as a month, 3 months, 6 months, a year, or more than a year. The hot melt composition which is at least partially covered with hollow glass particles may have a tack-free surface and/or may be free-flowing at ambient conditions or room temperature, i.e. at temperatures from 20 to 25° C., and/or at higher ambient temperatures, i.e. at temperatures from 25 to 40° C. Preferably, the hot melt composition which is at least partially covered with hollow glass particles may have a tack-free surface and/or may be free-flowing at temperatures from 20 to 40° C.

The term “free-flowing” as used in the present invention means that particulate units, preferably granules, of the hot melt composition are able to move freely and without any difficulty and/or any agglomeration. Preferably, “free-flowing” means that the particulate units still “flow” through an opening with a diameter of 5 cm by reason of its own weight, even after storage for 4 months, but at least for 2 months, at temperatures up to 40° C.

The term “tack-free” surface means that the surface of the prills provides only residual stickiness or is completely free of stickiness, without any adhesion of the prills to each-other.

### Further, Optional Components

The hot melt composition may comprise further, optional, components such as tackifying agents, plasticizers, stabilizers, antioxidants, pigments, dyes, ultraviolet light absorbers, anti-slip agents and combinations thereof.

According to one optional embodiment, the hot melt composition further comprises a tackifying agent, preferably in an amount from 5 to 75 wt.-% based on total weight of the hot melt composition, more preferably in an amount from 10 to 60 wt.-%, and most preferably in an amount from 15 to 50 wt.-%.

Useful tackifying agents include, e.g., natural and modified rosins such as gum rosin, wood rosin, tall oil rosin, distilled rosin, hydrogenated rosin, dimerized rosin and polymerized rosin; rosin esters such as glycerol, and pentaerythritol esters of natural and modified rosins; phenolic modified terpene, α-methyl styrene resins and hydrogenated derivatives thereof; aliphatic petroleum hydrocarbon resins having a Ball and Ring softening point of from about 70° C. to 135° C.; aromatic petroleum hydrocarbon resins, and mixed aromatic and aliphatic paraffin hydrocarbon resins and the hydrogenated derivatives thereof; aromatic modified alicyclic petroleum hydrocarbon resins and the hydrogenated derivatives thereof; alicyclic petroleum hydrocarbon resins and the hydrogenated derivatives thereof; low molecular weight polylactic acid; and combinations thereof. Preferably, aliphatic hydrocarbon resins or rosin esters of pentaerythritol are included as tackifying agents for APAO based hot melt compositions.

According to another, optional, embodiment of the present invention, the hot melt composition comprises a plasticizer, preferably in an amount from 1 to 20 wt.-% based on the total weight of the hot melt composition, more preferably in an amount from 1 to 10 wt.-%, and most preferably in an amount from 1 to 7 wt.-%.

Suitable plasticizers may include mineral based oils and petroleum based oils, liquid resins, liquid elastomers, polybutene, polyisobutylene, functionalized oils such as glycerol trihydroxyoleate and other fatty oils and mixtures thereof. A “plasticizer” in the meaning of the present invention is a typically organic composition that can be added to thermoplastics, rubbers and other resins to improve extrudability, flexibility, workability and stretchability in the finished adhesive. Any material which flows at ambient temperatures and is compatible with the block copolymer may be useful. The most commonly used plasticizers are oils which are primarily hydrocarbon oils that are low in aromatic content and are paraffinic or naphthenic in character. The oils are preferably low in volatility, transparent and have as little color and odor as possible. Furthermore, olefin oligomers, low molecular weight polymers, vegetable oils and their derivatives and similar plasticizing oils may be used as plasticizers.

Useful antioxidants are, e.g., high molecular weight hindered phenols and multifunctional phenols. Useful stabilizers are, e.g., phosphites, such as tris-(p-nonylphenyl)-phosphite (TNPP) and bis(2,4-di-tert-butylphenyl)4,4′-diphenylene-diphosphonite and di-stearyl-3,3′-thiodipropionate (DSTDP). Useful antioxidants are, e.g., commercially available under trade designation IRGANOX, including IRGANOX 1010, from Ciba (Terrytown, N.Y.), and under the trade designation BNX, including BXN 1010, from Mayzo, Inc. (Norcross, Ga.). Useful anti-slip agents are, e.g., silicone oils. Examples thereof are commercially available, e.g., under the trade designation Tegiloxan and available from Goldschmidt Industrial Specialties.

Preparation of Hot Melt Particulate Units and their Use

The hot melt particulate units of the present invention comprise a hot melt composition, wherein the surface of the particulate units is at least partially covered with hollow glass micro particles, e.g. at least one layer of hollow glass micro particles. The inventive hot melt particulate units, particularly granules, may be substantially tack-free and/or free flowing. The term “free-flowing” as used in the present invention means that the particulate units are able to move freely and without any difficulty and/or any agglomeration.

According to one embodiment of the present invention, a method for preparing hot melt particulate units comprises the steps of (a) providing particulate units of a hot melt composition, and (b) contacting the hot melt particulate units with hollow glass micro particles, to at least partially cover the surface of the particulate units with hollow glass micro particles adhering to the surface.

The inventive method allows the preparation of tack-free and/or free flowing hot melt particulate units.

Hot melt compositions granules, particularly prills, may be particularly suitable for use in vacuum feeders due to their small size and weight. However, due to the larger surface of prills compared to the larger pellets, prills may have a higher tendency to agglomerate. Thus, the present invention is specifically advantageous with small sized granules such as prills, although it equally works with pellets, flakes, blocks or any other form of particulate units of the inventive hot melt composition.

According to one embodiment, the hot melt particulate units of the present invention comprise a hot melt composition in the form of granules, wherein the surface of the granules is at least partially covered with hollow glass micro particles, e.g. at least one layer of hollow glass micro particles. The inventive hot melt granules may be substantially tack-free and/or free flowing.

According to one preferred embodiment of the present invention, a method for preparing hot melt granules, preferably prills, is provided comprising the steps of (a) providing granules of a hot melt composition, and (b) contacting the hot melt granules with hollow glass micro particles, to at least partially cover the surface of the granules with hollow glass micro particles adhering to the surface. Preferably, the hot melt granules have a substantially dry surface before contacting with hollow glass micro particles.

The inventive method allows the preparation of tack-free and/or free flowing hot melt granules, preferably prills.

The production of the hot melt granules, specifically prills, may require multiple passes through a co-rotating twin screw extruder to homogenize the hot melt composition, followed by an extrusion through a pelletizing system, followed by a drying process to extract all the residual water from the granules, followed by the calibration of the granules size. A suitable pelletizing system is, for example, the underwater pelletizer provided by Gala Industries Inc. (U.S.A.). However, any other system that is suitable to produce granules from hot melt compositions can also be used.

According to one embodiment, the granules of a hot melt composition provided in method step (a) are prepared by a method comprising the steps of
(i) providing one or more hot melt components and blending the hot melt components to form a homogeneous hot melt compositions,
(ii) forcing the homogeneous hot melt composition through a die having a series of voids in a circular pattern to form a series of homogeneous hot melt ribbons,
(iii) further forcing said homogeneous hot melt ribbons past rotating blades in parallel position to said die, and cutting the hot melt ribbons to form resultant granules,
(iv) solidifying the granules by use of a liquid cooling medium being circulated past said die and rotating blades on the side where the hot inch ribbons emerge, and
(v) transporting the hot melt granules to a drying area and removing liquid by blowing the obtained granules.

In a preferred embodiment, the granules produced from this method are prills.

Hot melt compositions and hollow glass micro particles that are suitable for preparing the inventive hot melt granules are described above. Optionally, the hot melt particulate units may comprise additional components such as described above.

The contacting of the particulate units of a hot melt composition with hollow glass micro particles according to the method step (b) may be carried out with any conventional method and equipment which is suitable for the deposition of the glass micro particles on said particulate units.

For example, the hollow glass micro particles may be simply powdered onto the particulate units, or the particulate units may be mixed in the respective amounts with the hollow glass micro particles, for example in a mixing device such as a drum mixer, paddle mixer, tumbling mixer, or screw mixer.

Another possibility to contact the particulate units with the hollow glass micro particles is to discharge the particulate units into a container, e.g., a storage bag, containing the hollow glass micro particles, and optionally, mixing the particulate units and the hollow glass micro particles in the container by movement, e.g. shaking, rolling etc.

According to one embodiment the hot melt particulate units are contacted with the hollow glass micro particles by mixing the particulate units with the hollow glass micro particles in a container, e.g. in a storage bag.

For the purpose of the present invention, the expression “mixing the particulate units with the hollow glass microparticles” means that the surface of the particulate units comprising a solid hot melt composition is contacted with the hollow glass microparticles.

The contacting of a hot melt composition with hollow glass micro particles prevents or reduces blocking of a hot melt composition. Thus, according to a further aspect the present invention is directed to a method to prevent or reduce blocking of a hot melt composition comprising contacting a hot melt composition in the form of particulate units with hollow glass micro particles. Said method may be carried out with freshly produced hot melt particulate units which are dried and cooled down to room temperature.

The inventive hot melt can be used as a hot melt pressure sensitive adhesive or hot melt adhesive, preferably in the production of hygiene articles, care articles, paper, packaging, furniture, textiles, footwear, in woodworking or construction industries. According to a preferred embodiment, the inventive hot melt composition is used as a hot melt pressure sensitive adhesive or hot melt adhesive in the production of furniture or in woodworking.

According to another embodiment, the inventive hot melt particulate units, preferably granules, are used as a hot melt pressure sensitive adhesive or hot melt adhesive, preferably in the production of hygiene articles, care articles, paper, packaging, furniture, textiles, footwear, in woodworking or construction industries. According to a preferred embodiment, the inventive hot melt particulate units, preferably granules, are used as a hot melt pressure sensitive adhesive or hot melt adhesive in the production of furniture or in woodworking.

The invention will now be described by way of the following examples. All parts, ratios, percents and amounts stated are by weight unless otherwise specified.

### EXAMPLES

### Anti-Blocking Additives

TABLE 1
Anti-blocking additives

| Additive | type of product | specific characteristics |
|---|---|---|
| A (comparative) | talc | average particle size d₅₀: 5.0 μm |
| B (comparative) | talc | average particle size d₅₀: 17.6 μm |
| C (comparative) | fumed silica | — |
| D (inventive) | hollow glass | average particle size d₅₀: 65 μm |
| | microspheres | density: 0.10-0.14 g/cm³ |

### Example 1

### Laboratory Experiments

Prills having a size of 3 to 5 mm of an APAO based hot melt composition (Rakoll SK PO 5430, H.B. Fuller Europe GmbH, Switzerland) were mixed with an additive of table 1 inside a plastic bag. The amounts of the hot melt and additives used are given in Table 2 below.

TABLE 2
Amounts of hot melt and additives used in example 1

| Amount of | | Amount of |
|---|---|---|
| hot melt (g) | Additive | additive (g) |
| 300 | A (comparative) | 1 |
| 300 | B (comparative) | 1 |
| 300 | C (comparative) | 1 |
| 300 | D (inventive) | 1 |

### Agglomeration Test

The agglomeration tendency of the prepared hot melt prills was tested as follows: 250 g of the hot melt prills were weighed into a 600 ml glass beaker (80×150 mm) and a cylindrical weight of 1 kg having a diameter at the base of 75 mm was placed over the hot melt sample in the beaker. The set was placed into a ventilated oven for 3 days at a temperature of 40° C. The sample was analyzed visually immediately after removing the set from the oven, and after allowing the set to stabilize at room temperature (about 23° C.) for 3 days. The results are compiled in Table 3 below.

TABLE 3
Agglomeration tendency of tested hot melt
samples with different additives.

| | Results | | |
|---|---|---|---|
| Additive used | at 40° C. | at 23° C. | Comments |
| no additive | +(+) | + | — |
| A (comparative) | ++(+) | ++ | Almost no additive on the |
| | | | surface of the hot melt |
| B (comparative) | +++ | ++ | Almost no additive on the |
| | | | surface of the hot melt |
| C (comparative) | ++++ | +++++ | Additive is visible on the |
| | | | hot melt |
| D (inventive) | ++++ | +++++ | Additive is visible on the |
| | | | hot melt |

Legend:
+ the hot melt prills do not flow out of the beaker, even forcing them manually
++ the hot melt prills flow with extreme difficulty (almost no flow); forcing manually, the prills are released
+++ the hot melt prills flow when the beaker is shaken
++++ the hot melt prills flow without shaking the beaker, but still with some agglomeration
+++++ the hot melt prills flow out of the beaker without any difficulty and without any agglomeration

### Example 2

### Industrial Experiments

Prills having a size of 3 to 5 mm of a APAO based hot melt composition (Rakoll SK PO 5433, H.B. Fuller Europe GmbH, Switzerland) were contacted with 0.5 to 0.7 wt.-%, based on the total amount of the hot melt composition, of an additive of table 1 by powdering the hot melt prills with the anti-blocking additive by means of a mixing device such as a drum mixer, paddle mixer, tumbling mixer, or screw mixer. The obtained at least partially coated hot melt prills were discharged into storage bags. In all cases, the quantity of additive was chosen such that the same visual coating was obtained as in the laboratory experiments of example 1.

The amounts of the hot melt are given in Table 4 below.

TABLE 4
Amounts of hot melt produced industrially
and additives used in example 2.

| | Amount of | | |
|---|---|---|---|
| Sample | hot melt (kg) | Additive | Comments |
| 1 | 800 | D (inventive) | discharged to 700 kg bag |
| 2 | 700 | D (inventive) | discharged to 700 kg bag |
| 3 | 700 | D (inventive) | discharged to 700 kg bag |
| | | | slightly more additive |
| | | | than in sample 2 |

### Agglomeration Test

The agglomeration tendency of the prepared hot melt samples was tested by storing the bags with the samples for 1, 3 and 6 months, and analyzing the prills visually. The following results were obtained:

### Sample 1:

After 1 month at room temperature, the hot melt prills were not agglomerated and the additive was visible on the surface of the hot melt prills.

After 6 months at room temperature, the hot melt prills were agglomerated, but the prills were easily releasable. The additive was not visible on the surface of the hot melt prills. However, the quantity was sufficient to promote the de-agglomeration of the hot melt prills.

### Sample 2:

After 1 month at room temperature, the hot melt prills were slightly agglomerated and the additive was visible on the surface of the hot melt prills. The prills were easily releasable. After 3 months at room temperature, the hot melt prills were very slightly agglomerated, but the mills were easily releasable. The additive was visible on the surface of the hot melt prills.

### Sample 3:

After 1 month at room temperature, the hot melt prills were not agglomerated and the additive was visible on the surface of the hot melt prills.

After 3 months at room temperature, the hot melt prills were very slightly agglomerated, but the prills were easily releasable. The additive was visible on the surface of the hot melt prills.

### Additional Comments:

In all situations, the prills comprising additive D (hollow glass microspheres) were easily releasable, even when some agglomeration was visible. This means that the prills are not glued together as it happens, for example, with tale. Furthermore, the hollow glass micro spheres virtually look like silica regarding the formation of clouds of dust but due to the bigger particle size of the glass micro spheres, the powder is less inhalable and the cloud tends to disappear much faster due to the quicker deposition of the particles.

### Example 3

### Films of the Inventive Hot Melt Granules

The hot melt prills produced with the additive D (hollow glass microspheres) were molten at a temperature of 190° C. The molten hot melt was manually spread on a siliconized paper to form films having a thickness of about 100 μm by means of a metal applicator with a gap size of 50 μm. The obtained films were smooth and without any visible grits or spots.

### Summary of the Examples

Talc (additives A and B) is easily absorbed by the hot melt over time, with the problem being more visible with high temperature (40° C.). The prills show heavy agglomeration, with almost no flowability. A higher talc particle size (additive B) slightly improves the anti-blocking behavior but does not solve this problem. Agglomeration and blocking is still observed.

Silica (additive C) shows good anti-blocking properties. However, handling of this type of product leads to the formation of dust clouds, which are harmful and involve health problems due to the small size of the silica particles.

The hollow glass micro spheres (inventive additive D) show excellent anti-blocking properties even when some absorption of the microspheres or some agglomeration of the prills happens. Adhesion on the granules is good. The prills are easily releasable and the anti-blocking effect lasts for several months. Since the hollow micro spheres do not have the health problems as associated with the use of silica, the use of hollow glass micro spheres provides a favorable, safe and environmentally friendly alternative to silica as an anti-blocking agent for hot melt adhesive granules.

1. A hot melt composition in the form of particulate units, the particulate units having a surface which is at least partially covered by hollow glass micro particles.

2. The composition of claim 1, wherein the micro particles have an average particle size d₅₀ from 5 μm to 150 μm.

3. The composition of claim 1, wherein the micro particles have a density of less than 0.30 g/cm³.

4. The composition of claim 1, wherein the micro particles are present in an amount from 0.2 to 5.0 wt. %.

5. The composition of claim 1, wherein the hollow glass microparticles are selected from silicon dioxide, quartz, soda-lime glass, borosilicate glass, sodium borosilicate glass, or soda-lime borosilicate glass, or any mixture thereof.

6. The composition of claim 1, wherein the hot melt composition comprises at least 10 wt.-% of at least one amorphous poly-α-olefin (APAO), based on the total weight of the hot melt composition.

7. The composition of claim 6, wherein the at least one amorphous poly-α-olefin is selected from homopolymers of propylene or copolymers of propylene with one or more α-olefin comonomer.

8. The composition of claim 1, wherein the hot melt composition further comprises a tackifying resin, in an amount from 5 to 75 wt.-% based on total weight of the hot melt composition.

9. The composition of claim 1, wherein the hot melt composition comprises a plasticizer.

10. The composition of claim 1, wherein the hot melt composition is a hot melt pressure sensitive adhesive.

11. The composition of claim 1, wherein the particulate units include at least one of granules, blocks, pillows, elongated ropes or rods.

12. The composition of claim 1, wherein the particulate units are granules having a size from 1 to 10 mm.

13. The composition of claim 1, wherein the hot melt composition has a tack-free surface and/or is free flowing at ambient conditions.

14. (canceled)

15. A method for preparing particulate units of hot melt, comprising the steps of
(a) providing particulate units of a hot melt composition, and
(b) contacting the particulate units with hollow glass micro particles, to at least partially cover the surface of the particulate units with hollow glass micro particles adhering to the surface.

16. The method of claim 15, wherein the particulate units are granules, the granules of step (a) being prepared by a method comprising the steps of
(i) providing one or more hot melt components and blending the hot melt components to form a homogeneous hot melt composition,
(ii) forcing the homogeneous hot melt composition through a die having a series of voids in a circular pattern to form a series of homogeneous hot melt ribbons,
(iii) further forcing said homogeneous hot melt ribbons past rotating blades in parallel position to said die, and cutting the hot melt ribbons to form resultant granules,
(iv) solidifying the granules by use of a liquid cooling medium being circulated past said die and rotating blades on the side where the hot melt ribbons emerge, and
(v) transporting the hot melt granules to a drying area and removing liquid by blowing the obtained granules.

17. A method to prevent or reduce blocking of a hot melt composition comprising contacting a hot melt composition in the form of particulate units with hollow glass micro particles.
